(19) United States
(12) Patent Application Publication
(10) Pub. No.: US 2026/0140791 A1
(43) Pub. Date: May 21, 2026

(54) INTEGRATING AND CATALOGUING MODEL CONTEXT PROTOCOLS FOR NETWORK ENVIRONMENTS

(71) Applicant: CITIBANK, N.A., New York, NY (US)

(72) Inventors: Jaya C. CHILAKAMARRI, Irving, TX (US); David R. CHARLES, Irving, TX (US); Usha S. YELLAPU, Irving, TX (US); Miriam SILVER, Tel Aviv (IL)

(73) Assignee: CITIBANK, N.A., New York, NY (US)

(21) Appl. No.: 19/447,824

(22) Filed: Jan. 13, 2026

Related U.S. Application Data
(63) Continuation-in-part of application No. 19/329,236, filed on Sep. 15, 2025.
Application No. 19/329,236 is a continuation of application No. 18/626,911, filed on Apr. 4, 2024, now Pat. No. 12,450,107.
(60) Provisional application No. 63/467,201, filed on May 17, 2023.

(51) Int. Cl. G06F 9/54; G06F 11/34

(52) U.S. Cl. CPC G06F 9/541; G06F 9/547; G06F 11/3409; G06F 16/254; G06F 16/289

(57) ABSTRACT

Presented herein are systems and methods for integrating model context protocols (MCPs) for use in network environments. A server may retrieve a data file comprising an MCP schema defining a plurality of functions of a MCP for a generative model for use in a network environment. The server may identify, from a plurality of domains, a domain using the MCP schema in the data file. The server may select, from a plurality of policies corresponding to the plurality of domains, a policy which the MCP schema is to be validated based on the domain. The server may determine that the MCP schema for the MCP is validated in the policy. The server may configure, based on determining that the MCP schema is validated, a data record on a database to indicate an approval of the MCP for use in the network environment.

### CROSS REFERENCE TO RELATED APPLICATIONS

The present application claims the benefit of and priority to under 35 U.S.C. § 120 as a continuation-in-part of U.S. application Ser. No. 19/329,236, titled “Integrating and Cataloguing Application Programming Interfaces for Network Environments,” filed Sep. 15, 2025, which claims the benefit of and priority to under 35 U.S.C. § 120 as a continuation of U.S. application Ser. No. 18/626,911, titled “Integrating and Cataloguing Application Programming Interfaces for Network Environments,” filed Apr. 4, 2024, which claims the benefit of priority under present application claims the benefit of priority under 35 U.S.C. § 119(e) to U.S. Provisional Application No. 63/467,201, titled “Governing APIs with Intelligence,” filed May 17, 2023, each of which is incorporated herein in their entireties by reference.

### TECHNICAL FIELD

This application generally relates to model context protocols (MCPs), and in particular, integrating and cataloguing MCPs for use in network environments.

### BACKGROUND

A model context protocol (MCP) may define a set of rules and protocols to allow different generative models to exchange data and interface with one another. Software developers may use the specified rules and protocols to access the functionality and data of one generative model from another generative model. There may be, however, several hinderances to adapting MCPs. For instance, there may be inconsistencies in the MCP rules or protocols, with varying naming conventions, endpoints, and formats. In another example, documentation for MCPs may be incomplete, outdated, or lacking, resulting in such MCPs being unusable to the software developers. These and other hinderances may be even more exacerbated with the use of a myriad of MCPs in network environments used by a multitude of users.

### SUMMARY

Model context protocols (MCPs) can be used to allow generative models (e.g., artificial intelligence (AI) agents implemented using large language models (LLMs) to orchestrate tools, data sources, and external services). Without proper management of the MCP ecosystem, however, the entire network environment may be exposed through MCP tools to security risks and other faults, such as data exfiltration or unauthorized access to various resources. Furthermore, the adoption of various MCPs may eventually result in a sprawl of several tools with overlapping or redundant capabilities, outdated or incomplete MCP metadata, or orphan tools without a clear owning or responsible entity, among others. Another challenge may include lack of interoperability or interfacing with records regarding the MCP tools and capabilities available for use in the network. Compounding these challenges, generative models provide probabilistic and context-sensitive outputs, and the behavior of such models may be difficult to steer using inputs.

MCP governance may be used to manage and administer the registration, validation, and usage of MCP tools within complex network environments, addressing some of these challenges. The MCP governance may define a set of processes and policies to ensure that MCP tools are described, validated, published, and used in a consistent and secure manner by AI agents and services in the network environments. There may be, however, a number of challenges in effectively enacting MCP governance. First, the MCP governance may lack any centralized system of record or capability registry, resulting in ambiguities in tool ownership and schemas and inadequate quality of MCP metadata. Second, there may be a lack of specific controls management, leading to frequent breaches in MCP-exposed controls, residual risks, and unauthorized use or access of sensitive information, among others. The lack of controls may allow for hidden instructions or content embedded in tool responses to influence control flow, potentially causing the model to create undesirable parameters and outputs. Third, the MCP governance may be deficient in lifecycle management through the entirety of the use of a given MCP tool, from registration and exposure through versioning, redundancy handling, and deprecation.

To address these and other technical challenges, a centralized service for an MCP management platform may validate, test, integrate, and monitor MCPs through their lifecycle, by categorizing and aligning MCP schemata and identifying any redundancies and deprecations of MCPs. The service may be a part of the network environment or separate from the network environment. The service may function as a single source of knowledge about MCPs in the given network environment with the use of a robust MCP catalogue. By actively monitoring metadata and performance metrics of the MCPs from the network, the service may update MCP records and update versioning. During the onboarding process, the service may also provide for codified controls and automated review. Through the lifecycle of a given MCP, the service may provide for automation and tooling for management, as well as observability into usage and analytics.

In registering an MCP, the service may receive a data file defining the MCP schemata for the MCP. The MCP schemata may have been generated using a dashboard interface provided by the service for an administrator device to submit a request for registration of an MCP for a given domain (e.g., a type of function or application). The dashboard interface may include a set of fields for the administrator to enter information about the MCP, in accordance with a schema pack for the given domain. The schema pack may ensure that the MCP schemata are standardized and consistent. Upon submission through the dashboard interface, the service may select a policy against which to check the new MCP schema. With the selection, the service may perform validation and performance tests on the MCP. The service may generate a score card indicating which validation and performance tests the submitted MCP has passed or failed. In addition, the service may use a generative model to fill in missing data or convert information into a standardized, canonical form. With the generation, the service may provide the score card for presentation on the dashboard interface. This may allow the administrator or developer to revise the MCPs using the score card provided on the dashboard. Until the MCP passes, the service may prohibit incorporation of the MCP into the network environment. One the MCP passes the tests, the service may be approved for use in the networked environment.

The service may also determine whether the new MCP schema is duplicative with any of the existing MCP schemata deployed on the network environment. The service may use the generative model to create a summarization of the MCP schemata and to a generate a set of embeddings that is a lower dimensional encoded representation of the summarization output. With the set of embeddings for the MCP schema, the service may search for other redundant MCP schemata. To identify, the service may compare a distance between the set of embeddings for the new MCP schema versus the set of embeddings for each candidate MCP schema. When the distance is within a threshold, the service may identify the new MCP as redundant in view of a previous MCP. Upon detecting multiple redundant MCPs, the service may use the generative model to generate a score of the capabilities of each MCP and may select the MCP with the score indicative of the broadest capability. With the selection, the service may transmit information about the selected MCP schema as well as information about other candidate MCPs for presentation via a user interface for a system administrator to confirm the selection. The information may include side-by-side comparison of the MCPs with an explanation for the selection of one of the MCPs. When approved, the service may integrate or deploy the MCP for use in the network environment by adding a record of the MCP in an MCP catalogue on a database.

With the incorporation of the MCP for use, the service may add the MCP schema to the MCP catalogue for the network environment. As the MCP is in use in the network environment, the service may monitor metadata associated with the MCP from a variety of data sources, including usage by generative models within the network environment and revisions by the administrator through the MCP management platform, among others. Using the metadata, the service may update the corresponding record in the MCP catalogue for the MCP. For example, the service may identify whether a given version is in use or deprecated, when the metadata indicates a lack or reduction in usage of the MCP. The service may also determine whether there are redundancies with MCPs by comparison the metadata across the MCPs for similar functionality and usage. The service may calculate various performance metrics using the metadata associated with the MCP. The information derived from the metadata may be stored and maintained on the MCP catalogue.

Through the dashboard interface, the administrator device may submit a query for MCPs from the MCP catalogue on the centralized service. With receipt, the service may search the MCP catalogue using the keywords of the query to find one or more MCPs. The service may return an identification of the MCPs for presentation on the dashboard interface on the administrator device. The service may also provide information derived from the metadata with the MCPs, such as whether the version is in use, an indication of redundancy in function with another MCP, and performance analytics, among others, for the dashboard interface. This may allow the administrator or developer to have insight on the usage of MCPs within the network environment.

In this manner, the service for an MCP management platform may provide for centralized records of MCPs available for use in the network environment, thereby alleviating or eliminating issues surrounding MCP sprawl. The use of templates for MCP schemata may ensure consistency and standardization. The application of the MCP schemata may also regulate and shape the operations of the generative models (e.g., AI agents) in interfacing with one another, such that the exchanged data are within expected and desired behavior. By controlling integration of MCPs into the network environment, the service may further ensure that the MCP schemata are successfully validated and tested prior to the integration. The continuous monitoring by the service may allow for lifecycle management of the MCPs from development, deployment, versioning, and deprecation. The centralized catalogue may also provide consistent and standardized information about MCPs, as well as performance metrics of the MCPs used in the network environment. With the improvement in the MCP governance for the network environment, the computing resources and network bandwidth of the servers and clients in the network environment may be more efficiently allocated. Furthermore, new MCPs may be deployed in a standard and consistent manner, thereby increasing the adaptation of newer functionality in the network environment.

In addition, by using the generative model, the service may combine normalization with semantic processing for the MCP schema, thereby providing a more complete and accurate definition of the MCP in a standardized, consistent format. The normalization may facilitate meaningful semantic comparisons of multiple MCP schema and detection of redundant MCPs in the network environment using embeddings representing the MCP schemata. The use of the generative model may also reduce or eliminate occurrences of redundant MCPs, thereby saving computing resources and bandwidth that would have otherwise been consumed in invoking functions of redundant MCPs.

Aspects of the present disclosure are directed to systems, methods, and non-transitory computer readable media for integrating model context protocols (MCPs) for use in network environments. One or more processors coupled with a non-transitory memory may retrieve a data file comprising an MCP schema defining a plurality of functions of a MCP for a generative model for use in a network environment. The one or more processors may identify, from a plurality of domains, a domain using the MCP schema in the data file. The one or more processors may select, from a plurality of policies corresponding to the plurality of domains, a policy defining a set of conditions against which the MCP schema is to be validated for integration of the MCP in the network environment based on the domain. The one or more processors may determine that the MCP schema for the MCP is validated in accordance with the set of conditions defined by the policy. The one or more processors may configure, based on determining that the MCP schema is validated, a data record on a database to indicate an approval of the MCP for use in the network environment. The one or more processors may execute an integration of the MCP to permit invocation of the plurality of functions of the MCP in the network environment.

In one embodiment, the one or more processors may determine that a second MCP schema for a second MCP is not validated in accordance with the set of conditions defined by the policy. The one or more processors may configure, based on determining that the second MCP schema is not validated, a second data record on the database to indicate a disapproval of the MCP for use in the network environment. The one or more processors may restrict invocation of a second plurality of functions defined by the second MCP schema for the second MCP. In another embodiment, the one or more processors may receive, from the network environment, metadata comprising usage data of the plurality of functions of the MCP for the generative model invoked by one or more second generative models. The one or more processors may update the data record for the MCP on the database using the usage data included in the metadata.

In yet another embodiment, the one or more processors may generate a metric indicating a degree of usage of the plurality of functions of the MCP of a first version based on metadata for the MCP of the first version. The one or more processors may determine that the MCP of the first version is deprecated based on the metric not satisfying a threshold. The one or more processors may transmit, to a second generative model, a message to indicate that the MCP of the first version is deprecated. In yet another embodiment, the one or more processors may identify a second version of the MCP to replace the first version of the MCP based on the metadata, responsive to determining that the first version is deprecated. The one or more processors may transmit, to the second generative model, the message to indicate replacement of the first version with the second version.

In yet another embodiment, the one or more processors may generate, using a second generative model, (i) a first plurality of embeddings corresponding to the MCP schema for the generative model and (ii) a second plurality of embeddings corresponding to a second MCP schema for a third generative model. The one or more processors may determine a redundancy between the MCP schema for the generative model and the second schema for the third generative model based on a comparison of the first plurality of embeddings and the second plurality of embeddings. In yet another embodiment, the one or more processors may update the data record for the MCP to indicate that the MCP schema is redundant. The one or more processors may restrict invocation of the plurality of functions defined by the MCP schema for the MCP, responsive to updating the data record.

In yet another embodiment, the one or more processors may generate, using a second generative model, (i) a first plurality of embeddings corresponding to the MCP schema for the generative model and (ii) a second plurality of embeddings corresponding to a second MCP schema for a third generative model. The one or more processors may determine a lack of redundancy between the MCP schema for the generative model and the second schema for the third generative model based on a comparison of the first plurality of embeddings and the second plurality of embeddings. The one or more processors may permit invocation of the plurality of functions defined by the MCP schema and of a second plurality of functions defined by the second schema.

In yet another embodiment, the one or more processors may determine a metric indicating a level of risk of the MCP to the network environment based on metadata of the MCP. The one or more processors may update the data record for the MCP using the metric indicating the level of risk. The one or more processors may control access to invocation of at least one of the plurality of functions of the MCP. In yet another embodiment, the one or more processors may permit one or more artificial intelligence (AI) agents to exchange data with the generative model via the MCP and to access the plurality of functions of the MCP for the generative model.

It is to be understood that both the foregoing general description and the following detailed description are exemplary and explanatory and are intended to provide further explanation of the embodiments described herein.

### BRIEF DESCRIPTION OF THE DRAWINGS

The accompanying drawings constitute a part of this specification, illustrate an embodiment, and together with the specification, explain the subject matter of the disclosure.

FIG. 1 illustrates a block diagram of a process for automation of application programming interface (API) governance across MCP life cycles, in accordance with an embodiment;

FIG. 2 illustrates a block diagram of a system for managing MCPs in network environments, in accordance with an embodiment;

FIG. 3 illustrates a block diagram of a system for integrating MCPs for use in network environments, in accordance with an embodiment;

FIG. 4 illustrates a block diagram of a system for finding redundant MCPs for use in network environments, in accordance with an embodiment;

FIG. 5 illustrates a block diagram of a system for aggregating metadata associated with MCPs from various data sources, in accordance with an embodiment;

FIG. 6 illustrates a block diagram of a system for accessing MCP catalogues used in network environments, in accordance with an embodiment;

FIG. 7A illustrates a screenshot of a user interface with a list of domains for MCP catalogues, in accordance with an embodiment;

FIG. 7B illustrates a screenshot of a user interface to search MCP catalogues, in accordance with an embodiment;

FIG. 7C illustrates a screenshot of a user interface including performance metrics for MCPs, in accordance with an embodiment;

FIG. 8 illustrates a flow diagram of a method of integrating MCPs for use in networked environments, in accordance with an embodiment; and

FIG. 9 illustrates a flow diagram of a method of cataloguing MCPs using metadata, in accordance with an embodiment.

### DETAILED DESCRIPTION

Reference will now be made to the embodiments illustrated in the drawings, and specific language will be used here to describe the same. It will nevertheless be understood that no limitation of the scope of the disclosure is thereby intended. Alterations and further modifications of the features illustrated here, and additional applications of the principles as illustrated here, which would occur to a person skilled in the relevant art and having possession of this disclosure, are to be considered within the scope of the disclosure.

Presented herein is a centralized service for an MCP management platform that may validate, test, integrate, and monitor MCPs through their lifecycle, by categorizing and aligning MCP schema and identifying any redundancies and deprecations of MCPs. The service may be a part of the network environment or separate from the network environment. The service may function as a single source of knowledge about MCPs in the given network environment with the use of a robust MCP catalogue. By actively monitoring metadata and performance metrics of the MCPs from the network, the service may update MCP records and update versioning. During the onboarding process, the service may also provide for codified controls and automated review. Through the lifecycle of a given MCP, the service may provide for automation and tooling for management, as well as observability into usage and analytics.

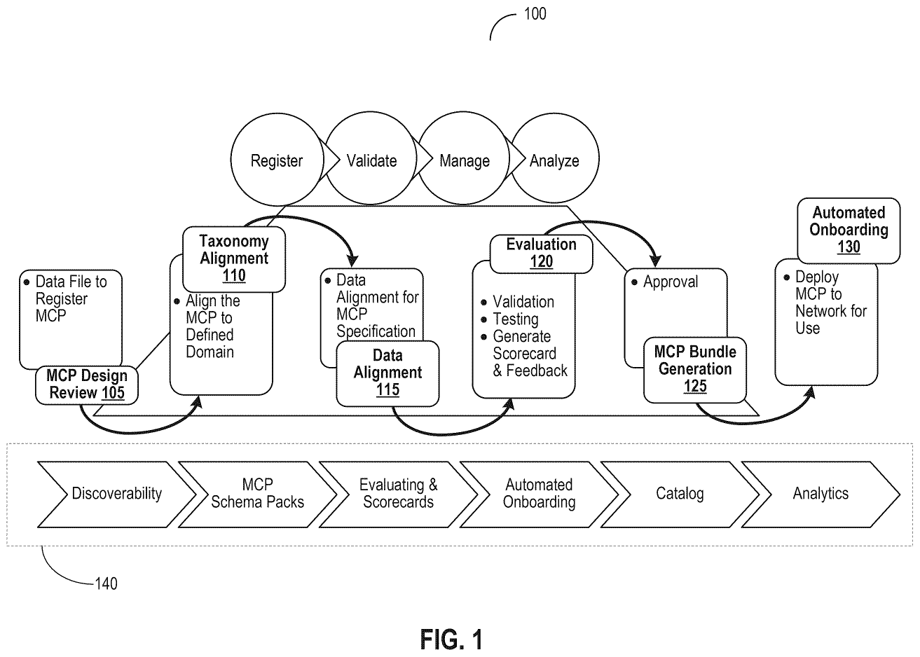

FIG. 1 illustrates a block diagram of a process 100 for automation of application programming interface (API) governance across MCP life cycles. The process 100 may be implemented or performed by a service associated with an MCP management platform. Under the process 100, at step 105, the service may conduct an MCP analysis, upon receiving a request to register an MCP with the network environment. The request may include a schema for the MCP generated in accordance with an MCP schema pack. At step 110, the service may align the MCP by standardizing the MCP schema in accordance with a defined domain. The domain may correspond to a type of function or application in which the MCP is to be used. In some embodiments, the service may use an internal generative model to correct and standardize the MCP. At step 115, the service may align the associated data in accordance with the domain defined for the MCP.

Continuing on, at step 120, the service may evaluate the MCP by performing validation and testing. Based on the validation and testing, the service may generate a score card of the MCP and feedback for the developer. At step 125, if the MCP has been successfully validated and tested, the service may determine that the MCP is approved for use in a network environment. At step 130, the service may generate an MCP bundle to integrate the MCP into the environment. At step 135, the service may perform automated onboarding of the MCP onto the network for use. The process 100 may correspond to a sequence 140 for the life cycle of managing the MCP. The sequence 140 may include discoverability of the MCP schema, using MCP design templates, with evaluating and scorecard generation, automated onboarding, cataloging, and monitoring analytics.

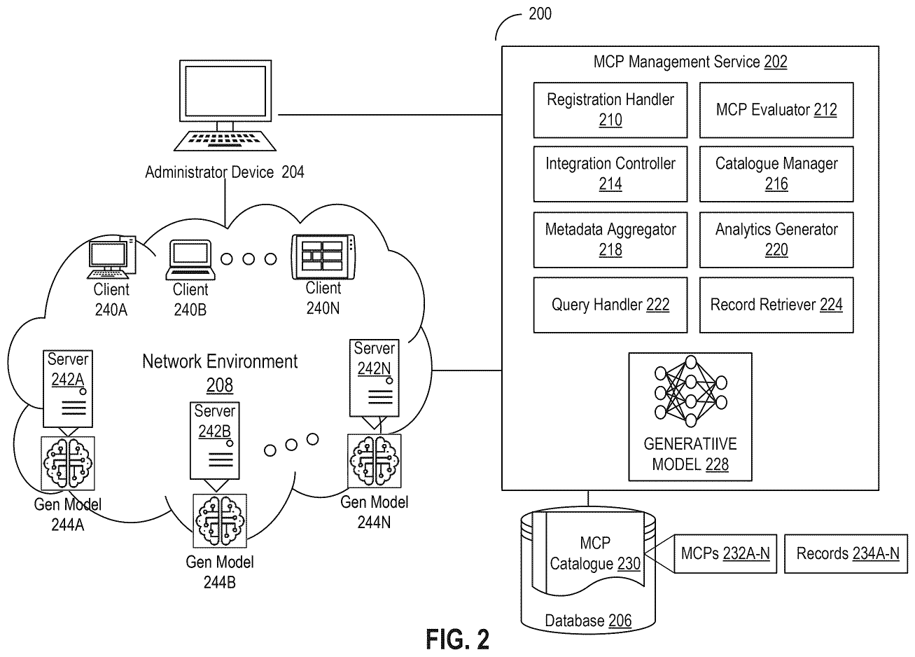

FIG. 2 illustrates a block diagram of a system 200 for managing model context protocols (MCPs) in network environments. The system 200 may include at least one MCP management service 202, at least one administrator device 204, at least one database 206, and at least one network environment 208, among others. The MCP management service 202 may include at least one registration handler 210, at least one MCP evaluator 212, at least one integration controller 214, at least one catalogue manager 216, at least one metadata aggregator 218, at least one analytics generator 220, at least one query handler 222, at least one record retriever 224, and at least one generative model 226, among others. The database 206 may store, maintain, or otherwise include at least one MCP catalogue 230, among others. The MCP catalogue 230 may identify a set of MCPs 232A-N (hereinafter generally referred to as MCPs 232) and a corresponding set of records 234A-N (hereinafter generally referred to as records 234). The network environment 208 may include one or more clients 240A-N (hereinafter generally referred to as clients 240) and one or more servers 242A-N (hereinafter generally referred to as servers 242). Each server 242 may host or include at least one artificial intelligence (AI) agent 244A-N (hereinafter generally referred to as AI agents 244), among others.

Embodiments may comprise additional or alternative components or omit certain components from those of FIG. 2 and still fall within the scope of this disclosure. For example, the MCP management service 202, the administrator device 204, and database 206 may be part of the same device. Various hardware and software components of one or more public or private networks may interconnect the various components of the system 200. Non-limiting examples of such networks may include Local Area Network (LAN), Wireless Local Area Network (WLAN), Metropolitan Area Network (MAN), Wide Area Network (WAN), and the Internet. The communication over the network may be performed in accordance with various communication protocols, such as Transmission Control Protocol and Internet Protocol (TCP/IP), User Datagram Protocol (UDP), and IEEE communication protocols.

The MCP management service 202 may be any computing device including one or more processors coupled with memory and software and capable of performing the various processes and tasks described herein. The MCP management service 202 may be part of an MCP governance or management platform to control and administer MCPs 232 used in network environments, such as the network environment 208. The MCP management service 202 may be in communication with the administrator device 204, the database 206, and the network environment 208, among others. Although shown as a single MCP management service 202, the MCP management service 202 may include any number of computing devices. The MCP management service 202 may interface with the administrator device 204 to exchange data associated with MCPs to be integrated or onboarded in the network environment 208. The MCP management service 202 may communicate with the network environment 208 to exchange metadata and performance data about MCPs in use among the clients 240, the servers 242, and the AI agents 244 of the network environment 208. The MCP management service 202 may control and manage the usage of MCPs within the network environment 208.

The MCP management service 202 may include several subsystems to perform the operations described herein. In the MCP management service 202, the registration handler 210 may receive a request to onboard MCPs for use under defined domains on the network environment 208. The MCP evaluator 212 may execute validation and performance testing on the MCPs 232 in accordance with policies for domains. The integration controller 214 may manage integration of the MCPs 232 based on the results of the validation and testing. The catalogue manager 216 may maintain the MCP catalogue 230 on the database 206 of MCP schemata and related data for MCPs 232 approved for use in the network environment 208. The metadata aggregator 218 may retrieve metadata and related data associated with the MCP from various sources, including the administrator device 204 and the network environment 208. The analytics generator 220 may carry out analytics on the metadata associated with MCPs. The query handler 222 may receive queries for MCPs 232 on the MCP catalogue 230. The record retriever 224 may search for MCPs corresponding to the queries.

The generative model 226 may include any AI algorithm or machine learning (ML) model to generate output with statistical characteristics consistent with training corpuses that the model was trained on, when given the input. The generative model 226 may include, for example, a transformer-based deep neural network (e.g., large language model (LLM) such as a generative pre-trained transformer (GPT) or a bidirectional encoder representation from transformer (BERT)), variational autoencoder (VAE), or a generative adversarial network (GAN), among others. In general, the generative model 226 may include an input, outputs, and a set of weights arranged across a set of layers to relate the input and the output. The input may include a prompt (e.g., alphanumeric characters or strings) or tokens. The set of weights may be arranged or configured in accordance with the ML architecture used for the generative model 226.

The administrator device 204 may be any computing device operable by a user to interface with the MCP management service 202. For example, the administrator device 204 may be operated or used by an entity associated with a software developer to design and add MCPs 232 for use in the network environment 208. In some cases, the entity associated with the administrator device 204 may be an administrator of the network environment 208. The administrator device 204 may include any number of computing devices and may be in communication with the MCP management service 202 and the network environment 208, among others.

The database 206 may store and maintain various data associated with the MCPs, such as the MCP catalogue 230, or any other data from the MCP management service 202, the administrator device 204, and the network environment 208, among others. The MCP catalogue 230 may include or identify a set of MCP records 234 for corresponding MCPs 232 approved for use in the network environment 208. Each MCP 232 may define, identify, or otherwise include a set of protocols or definitions to permit communications and interfacing among the AI agents 244 in the network environment 208. Each record 234 may identify or include information related to the respective MCP 232, such as the metadata and performance analytics, among others. The database 206 may also include a database management system (DBMS) to arrange and organize the data maintained thereon. The data stored and maintained on the database 206 may be in accordance with at least one data scheme. The database 206 may be in communication with the MCP management service 202, the administrator device 204, and the network environment 208, among others.

The network environment 208 may include or correspond to a defined network in which the set of clients 240 and the servers 242 may be in communication with one another. For example, the network environment 208 may correspond to an enterprise network, with clients 240 spread across multiple locales and servers 242 residing in data centers or branch offices, among others. To facilitate such communications, the network for the network environment 208 may include one or more of: Local Area Network (LAN), Wireless Local Area Network (WLAN), Metropolitan Area Network (MAN), Wide Area Network (WAN), software-defined networking (SDN), virtual private networks (VPNs), and the Internet, among others. The communication over the network may be performed in accordance with various communication protocols, such as Transmission Control Protocol and Internet Protocol (TCP/IP), User Datagram Protocol (UDP), and IEEE communication protocols.

In some embodiments, the network environment 208 may include a cloud-based service, e.g. Software as a Service (SaaS), Platform as a Service (PaaS), and Infrastructure as a Service (IaaS). IaaS may refer to a user renting the use of infrastructure resources that are needed during a specified time period. IaaS providers may offer storage, networking, servers or virtualization resources from large pools, allowing the users to quickly scale up by accessing more resources as needed. PaaS providers may offer functionality provided by IaaS, including, e.g., storage, networking, servers or virtualization, as well as additional resources such as, e.g., the operating system, middleware, or runtime resources. SaaS providers may offer the resources that PaaS provides, including storage, networking, servers, virtualization, operating system, middleware, or runtime resources. In some embodiments, SaaS providers may offer additional resources including, e.g., data and application resources.

Each client 240 may be any computing device including one or more processors coupled with memory and software and capable of performing the various processes and tasks described herein. Each client 240 may be associated with an end user entity within the network environment 208. For example, the client 240 may be a virtual machine associated with a member of an enterprise network. The client 240 may be in communication with the servers 242, the network environment 208, the administrator device 204, and the MCP management service 202, among others.

Each server 242 may be any computing device including one or more processors coupled with memory and software and capable of performing the various processes and tasks described herein. The server 242 may host or include resources for at least one of the AI agents 244 to be accessed by one of the clients 240. The server 242 may be associated with an entity maintaining the respective AI agent 244. For instance, the server 242 may be maintained by the same entity that developed the AI agent 244. The server 242 may be in communication with the clients 240, the network environment 208, the administrator device 204, and the MCP management service 202, among others.

Each AI agent 244 may include any AI algorithm or machine learning (ML) model to generate output with statistical characteristics consistent with training corpuses that the model was trained on, when given the input. Each AI agent 244 may communicate or interface with other AI agents 244 in the network environment 208 via one or more MCPs. Each MCP may be defined by an MCP schema. The MCP schema may include a definition of: one or more capabilities (or functions); a structure of input prompts including parameters; a structure of output responses from the AI agent using the MCP. The AI agent 244 may be implemented using or may include, for example, a transformer-based deep neural network (e.g., large language model (LLM) such as a generative pre-trained transformer (GPT) or a bidirectional encoder representation from transformer (BERT)), variational autoencoder (VAE), or a generative adversarial network (GAN), among others. In general, the AI agent 244 may include an input, outputs, and a set of weights arranged across a set of layers to relate the input and the output. The input may include a prompt (e.g., alphanumeric characters or strings) or tokens. The set of weights may be arranged or configured in accordance with the ML architecture used for the AI agent 244. In some embodiments, the AI agent 244 may include other architectures, such as artificial neural network (ANN) (e.g., convolutional neural network (CNN) or recurrent neural network (RNN)) a clustering algorithm, a support vector machine (SVM), a Naïve Bayesian classifier, a decision tree, a random forest classifier, among others.

The MCP management service 202 (or the platform) may reside within or outside the network environment 208 for which MCP management service 202 is managing MCPs 232. In some embodiments, the network environment 208 may include the MCP management service 202. For example, the MCP management service 202 may reside within the same network as the clients 240 and servers 242, manage and administer the MCPs from within the network environment 208, and interface with the administrator device 204 outside the network environment 208. In some embodiments, the network environment 208 may include the administrator device 204. For instance, the administrator device 204 may interface within the MCP management service 202 outside the network environment 208 to manage and administer MCP usage within the network environment 208.

In some embodiments, the network environment 208 may include the MCP management service 202 and the administrator device 204. For example, both the MCP management service 202 and the administrator device 204 may be part of the network environment 208 to manage and administer MCPs used internally within the network environment 208. In some embodiments, the network environment 208 may be separate from the MCP management service 202 and the administrator device 204. For instance, the administrator of the network environment 208 may interface with the MCP management service 202 to add and provide specifications for the MCPs 232 for use in network environments, such as the network environment 208. The MCP management service 202 in turn may monitor data within the network environment 208 from outside.

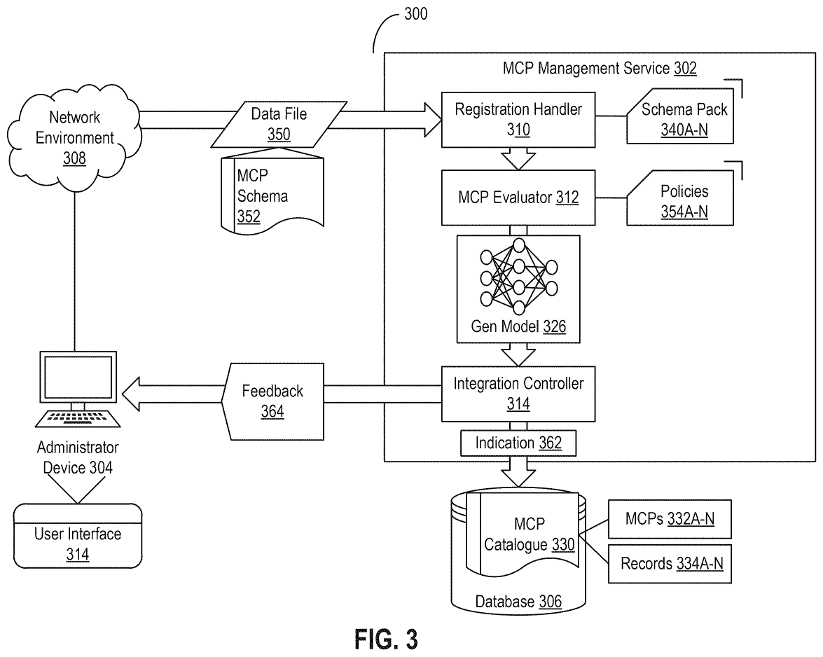

FIG. 3 illustrates a block diagram of a system 300 for integrating model context protocols (MCPs) for use in network environments. The system 300 may include at least one MCP management service 302, at least one administrator device 304, and at least one database 306, among others. The MCP management service 302 may include at least one registration handler 310, at least one MCP evaluator 312, at least one integration controller 314, and at least one generative model 326, among others. The administrator device 304 may provide at least one user interface 316, among others. The database 306 may store or include the MCP catalogue 330, among others. The MCP catalogue 330 may include or identify a set of MCPs 332A-N (hereinafter generally referred to as MCPs 332) and a corresponding set of records 334A-N (hereinafter generally referred to as records 334).

Embodiments may comprise additional or alternative components or omit certain components from those of FIG. 3 and still fall within the scope of this disclosure. Various hardware and software components of one or more public or private networks may interconnect the various components of the system 300. Each component in system 300 (such as the MCP management service 302, the administrator device 304, and the database 306) may be any computing device comprising one or more processors coupled with memory and software, and capable of performing the various processes and tasks described herein.

The registration handler 310 of the MCP management service 302 stores or maintains a set of schema packs 340A-N (hereinafter generally referred to schema packs 340). The set of schema packs 340 may be stored and maintained (e.g., as one or more data structures or files) on the database 306. Each schema pack 340 may specify, define, or otherwise identify a format for the information to be included for defining at least one MCP 332. The format may define or specify a standardized structure for the arrangement of the information for the MCP 332. Each schema pack 340 may be associated with one or more respective domains. The domains may correspond to or otherwise be associated with a type of function or tool associated with the MCP 332. The domains may, for example, include various functions of a banking application, such as account management, customer data management, risk management, and messaging, among others. The schema packs 340 may be defined or configured by an administrator or entity associated with the MCP management service 302. In some embodiments, the domain may correspond to a region, such as, for example, geographic region (e.g., a municipality, a province, a state, a country, or a set of countries in a given area), an organization (e.g., an enterprise, data center, or branch office), or any subset of AI agents in the network environment 308.

The schema pack 340 may specify the format for information for the MCP 332 itself such as, a name of an associated AI agent (or tool), an identifier for a resource (e.g., uniform resource identifier (URI)), an input schema defining a structure for the input to the tool (e.g., prompt with placeholders and defined strings), an output schema defining a structure of the output from the tool, and metadata, among others. The schema pack 340 may also define the format for metadata associated with the MCP 332, such as a domain identifier, an MCP identifier, an MCP version, an MCP life cycle stage (e.g., review, testing, validation, onboarding, integrated, or deprecated), a gateway identifier (e.g., the server hosting the associated AI agent), a product identifier (e.g., the associated AI agents), an MCP version, an owner identifier, an MCP type, a data classification (e.g., of the data exchanged through the MCP 332), an authorization level, a geographical region, or organizations, among others. The schema pack 340 may specify the format for the documentation in accordance with a respective domain. For example, the schema pack 340 may specify information to be included pertinent to the type of function or tool associated with the MCP 332, such as security measures to handle communication of sensitive information.

The registration handler 310 may send, transmit, or otherwise provide the user interface 316 to the administrator device 304. In some embodiments, the registration handler 310 may transmit or send an instruction to display, render, or otherwise present the user interface 316 via the administrator device 304. The user interface 316 may be a graphical user interface of an application (e.g., web application) supported by the MCP management service 302. The user interface 316 may include one or more fields (e.g., user interface elements) for defining an MCP 332. The fields may include or identify, for example: information for the MCP 332 itself (e.g., a name of an associated AI agent (or tool), an identifier for a resource (e.g., uniform resource identifier (URI)), an input schema defining a structure for the input to the tool (e.g., prompt with placeholders and defined strings), and an output schema defining a structure of the output from the tool); metadata for the MCP 332 (e.g., a domain identifier, an MCP identifier, an MCP version, life cycle stage, a gateway identifier, a product identifier, an MCP version, an owner identifier, an MCP type, a data classification, an authorization level, a geographical region, or organizations); and documentation for the MCP 332, among others. In some embodiments, the fields of the user interface 316 may be defined in accordance with one of the schema packs 340. For example, the administrator device 304 may have requested the user interface 316 to define the MCP 332 for a particular domain. The registration handler 310 in turn may provide the instructions for presenting the user interface 316 with fields to define the information in accordance with the schema pack 340 of the domain.

The administrator device 304 may retrieve, obtain, or otherwise receive the user interface 316 from the MCP management service 302. For instance, the administrator device 304 may receive the instruction for presentation of the user interface 316 from the MCP management service 302. With the receipt, the administrator device 304 may present the user interface 316 via a display, and may accept user inputs on the user interface 316. Using the inputs on the user interface 316, the administrator device 304 may create, write, or otherwise generate at least one data file 350. The data file 350 may identify or include at least one MCP schema 352 for the MCP 332. The MCP 332 may be associated with at least one AI agent to be integrated with the network environment 308. The MCP schema 352 may include the information inputted via the fields of the user interface 316. In some embodiments, the administrator device 304 may generate the MCP schema 352 in an initial format (e.g., different from the schema packs 340). In some embodiments, the administrator device 304 may generate the MCP schema 352 in accordance with the schema pack 340 corresponding to the identified domain. With the generation, the administrator device 304 may provide, transmit, or otherwise send the data file 350 including the MCP schema 352 to the MCP management service 302. The data file 350 may be in any format for defining the MCP schema 352, such as JavaScript Object Notation (JSON), Extensible Markup Language (XML), or YAML, among others.

The registration handler 310 retrieves, identifies, or otherwise receives the data file 350 from the administrator device 304. In some embodiments, the registration handler 310 may intercept, obtain, or otherwise retrieve the data file 350 (or data associated with the MCP 332) from the network environment 308. In some embodiments, the registration handler 310 may obtain or receive the data file 350 as part of a registration request to integrate the MCP 332 in the network environment 308. With receipt, the registration handler 310 may process or parse the data file 350 to extract or identify the MCP schema 352. The registration handler 310 may extract or identify the information from the MCP schema 352. From the MCP schema 352, the registration handler 310 may extract or identify information for the MCP 332 itself (e.g., a name of an associated AI agent (or tool), an identifier for a resource (e.g., uniform resource identifier (URI)), an input schema defining a structure for the input to the tool (e.g., prompt with placeholders and defined strings), an output schema defining a structure of the output from the tool); metadata for the MCP 332 (e.g., a domain identifier, an MCP identifier, an MCP version, life cycle stage, a gateway identifier, life cycle stage, a product identifier, an MCP version, an owner identifier, an MCP type, a data classification, an authorization level, a geographical region, or organizations); and documentation for the MCP 332. In addition, from the information of the MCP schema 352, the registration handler 310 may also determine or identify at least one domain associated with the MCP 332 defined by the schema 352.

With the identification of the domain, the registration handler 310 may identify or select the schema pack 340 corresponding to the domain associated with the MCP schema 352. The registration handler 310 may change, alter, or otherwise modify the MCP schema 352 in accordance with the schema pack 340. In some embodiments, the registration handler 310 may convert or translate the information included in the MCP schema 352 into the format defined by the schema pack 340. For example, the registration handler 310 may perform alignment by inserting the information from the MCP schema 352 into the structure of the standardized format specified by the schema pack 340 for the domain. The registration handler 310 may store and maintain the standardized MCP schema 352.

In some embodiments, using the data file 350 retrieved from the network environment 308, the registration handler 310 may apply or execute the generative model 326. The generative model 326 may have been trained or fine-tuned to generate any number of outputs related to MCP schema. The generative model 326 may have been trained or fine-tuned using a corpus. In some embodiments, the corpus may include MCP schema in non-normalized form (e.g., unstructured and free text) and normalized form (e.g., in expected, standard or canonical form). A portion of the corpus, including the MCP schema in the non-normalized form may be identified as a source set, and another portion of the corpus including the MCP schema in the normalized form may be identified as a destination set. The generative model 326 may be provided (e.g., by the MCP management service 302) with the source set as input and may generate an output. A distribution of the tokens in the output from the generative model 326 may be compared with a distribution of tokens in the expected output as derived from the destination set. Based on the comparison, a loss metric (e.g., cross-entry loss, a divergence loss, or mean average loss) may be calculated and the loss metric may be used to update the one or more weights in the generative model 326. To execute the generative model 326, the registration handler 310 may generate and provide a prompt directing the generative model 326 to generate the MCP schema 352 in a normalized form (e.g., canonical form).

Based on executing the generative model 326, the registration handler 310 may alter or modify the MCP schema 352. The MCP schema 352 received via the data file 350 may be in an unstructured format and have certain missing data. The generative model 326 may be used to convert the MCP schema 352 into the structured format and to fill in the missing data. The MCP schema 352 generated using the generative model 326 may include information about the MCP 332 (e.g., a name of an associated AI agent (or tool), an identifier for a resource (e.g., uniform resource identifier (URI)), an input schema defining a structure for the input to the tool (e.g., prompt with placeholders and defined strings), an output schema defining a structure of the output from the tool) in a structured, standardized, canonical form. The MCP schema 352 may include a set of fields and a corresponding set of values in accordance with the canonical form. The set of fields and the corresponding set of values may define the set of functions available for invocation to the one or more AI agents 544 in the network environment via the MCP 332. In some embodiments, in applying the generative model 326, the registration handler 310 may determine or identify at least one field corresponding to a missing value in the set of values in the MCP schema 352. For each field with a missing value, the registration handler 310 may apply the generative model 326 using the data associated with the MCP schema 342 to generate a new value to include in the field.

The MCP evaluator 312 of the MCP management service 302 may store and maintain a set of policies 354A-N (hereinafter generally referred to as policies 354). The set of policies 354 may be stored and maintained (e.g., as one or more data structures or files) on the database 306. Each policy 354 may specify, identify, or otherwise define a set of rules or criterion (sometimes herein generally referred to as conditions) that the MCP 332 is to satisfy in order to be approved for use in the network environment. Each policy 354 may be associated with at least one respective domain. For instance, the policy 354 for MCPs to be used in banking customer tools may differ from the policy 354 for MCPs to be used in database query retrieval tools.

Each policy 354 may include a set of conditions (or rules) for validation and a set of conditions for testing, among others. The conditions for validation may identify, for example, data criteria (e.g., expected format of data exchanged through MCP 332), documentation criteria (e.g., checking for inclusion of information), and compliance criteria (e.g., handling and encryption of data), among others. The conditions for testing may identify, for instance, criteria for functionality (e.g., proper operations) and performance metrics (e.g., response times, throughput, and system utilization), among others. The conditions for validation and testing may be specific for the domain. For example, the policy 354 may specify that data communicated for MCPs related to banking tools that exchange sensitive information (e.g., personally identifying information (PII) or transaction related data) are to be of a certain encryption level.

The MCP evaluator 312 selects or identifies at least one policy 354 from the set of policies 354 based on the domain associated with the MCP 332. In some embodiments, the MCP evaluator 312 may select the policy 354 based on the domain identified in the schema pack 340 with which the MCP schema 352 is defined. With the identification of the policy 354, the MCP evaluator 312 may identify or determine whether the MCP 332 is validated. The validation may be to permit, allow, or otherwise approve the MCP 332 for use in the network environment. In some embodiments, the MCP evaluator 312 may perform the validation, in response to a separate request from the administrator device 304.

To validate, the MCP evaluator 312 may check the MCP 332 (or the MCP schema 352) using the set of rules defined by the policy 354. The set of rules may include the rules for validation in the policy 354. For each rule of the policy 354, the MCP evaluator 312 may determine whether the MCP 332 satisfies the criterion defined by the rule. If the MCP 332 satisfies the criterion, the MCP evaluator 312 may determine that the MCP 332 is in compliance with the rule. Conversely, if the MCP 332 does not satisfy the criterion, the MCP evaluator 312 may determine that the MCP 332 is in not compliance with the rule. When the MCP 332 is in compliance with all the rules, the MCP evaluator 312 may determine that the MCP 332 is validated. Otherwise, when the MCP 332 is not in compliance with all the rules, the MCP evaluator 312 may determine that the MCP 332 is not validated. In some embodiments, the MCP evaluator 312 may identify a subset of rules that the MCP 332 is not in compliance with (e.g., not validated) and a remaining subset of rules that the MCP 332 is in compliance with (e.g., validated).

In some embodiments, the MCP evaluator 312 may identify or determine whether the MCP 332 satisfies a functionality (or performance) criterion using the set of rules defined by the policy 354. The set of rules may include the rules for testing as defined by the policy 354. For each rule of the policy 354, the MCP evaluator 312 may determine whether the MCP 332 satisfies the criterion defined by the rule. If the MCP 332 satisfies the criterion, the MCP evaluator 312 may determine that the MCP 332 is in compliance with the rule. Conversely, if the MCP 332 does not satisfy the criterion, the MCP evaluator 312 may determine that the MCP 332 is not in compliance with the rule. When the MCP 332 is in compliance with all the rules, the MCP evaluator 312 may determine that the MCP 332 satisfies the functionality criterion. Otherwise, when the MCP 332 is not in compliance with all the rules, the MCP evaluator 312 may determine that the MCP 332 does not satisfy the functionality criterion. In some embodiments, the MCP evaluator 312 may identify a subset of rules that the MCP 332 is not in compliance with and identify a remaining subset of rules that the MCP 332 is in compliance.

The integration controller 314 on the MCP management service 302 produces, creates, or otherwise generates at least one indication 362 based on determining whether the MCP 332 is validated. When the MCP 332 is determined to be validated, the integration controller 314 may generate the indication 362 to approve the MCP 332 for use in the network environment. When the MCP 332 is determined to not be validated, the integration controller 314 may generate the indication 362 to disapprove the MCP 332 for use in the network environment. In some embodiments, the integration controller 314 may generate the indication 362 based on determining whether the MCP 332 is validated and whether the MCP 332 satisfies the functionality criterion. When the MCP 332 is determined to be validated and satisfy the functionality criterion, the integration controller 314 may generate the indication 362 to approve the MCP 332 for use in the network environment. When the MCP 332 is determined to be not validated or not satisfy the functionality criterion, the integration controller 314 may generate the indication 362 to disapprove the MCP 332 for use in the network environment 308.

With the generation of the indication 362, the integration controller 314 may store and maintain an association between the MCP 332 (or the MCP schema 352) and the indication 362 on the database 306. The integration controller 314 may add, insert, or otherwise include the association of the MCP 332 (or the MCP schema 352 standardized according to the schema pack 340) as a record 334 in the MCP catalogue 330. When the indication 362 is to approve the MCP 332 for use in the network environment, the integration controller 314 may configure at least one record 334 on the database 306. The record 334 may indicate the approval of the MCP 332 (and the associated MCP schema 352) for use in the network environment 308. In some embodiments, the integration controller 314 may store and maintain the association to permit the use of the MCP 332 in the network environment.

The integration controller 314 may perform integration of the MCP 332 for use by the one or more AI agents in the network environment. The integration may include permitting the AI agents (e.g., other generative models) to invoke functions defined by the MCP schema 352 to exchange data with the AI agents associated with the MCP 332. By interfacing and exchanging data, the AI agents in the network environment 308 may access resources and functions of the MCP 332 for the AI agent. In addition, the integration may allow developers associated with the network environment to access documentation related to the MCP 332 through the database 306. The integration controller 314 may also create or generate an MCP bundle using the MCP schema 352 to make the MCP 332 available for use in the network environment. Conversely, when the indication 362 is to disapprove the MCP 332 for use in the network environment, the integration controller 314 may store the association to restrict the use of the MCP 332 in the network environment. In some embodiments, the integration controller 314 may configure the record 334 to restrict invocation of the functions defined by the MCP schema 352 of the MCP 332 in the network environment 308. By restricting, the AI agents in the network environment may be prevented from invoking functions defined by the MCP 332 and developers associated with the network environment may not access documentation related to the MCP 332.

In some embodiments, the integration controller 314 may determine, produce, or otherwise generate at least one feedback 364 to provide to the administrator device 304. The feedback 364 may include or identify the indication 362 of approval or disapproval of the MCP 332. In some embodiments, when the MCP 332 is determined to not be validated or not satisfy the functionality criterion, the integration controller 314 may generate the feedback 364 to include an identification of which rules the MCP 332 is in compliance with and which rules that MCP 332 is not in compliance with. In some embodiments, when the MCP 332 is determined to be not validated or not satisfy the functionality criterion, the integration controller 314 may determine or generate a validation score for the MCP 332. The validation score may be based on which subset of rules that the MCP 332 is not in compliance with and a remaining subset of rules that the MCP 332 is in compliance. The validation score may indicate a degree of compliance with the policy 354. The integration controller 314 may generate the feedback 364 to include the validation score. With the generation, the integration controller 314 may provide, send, or transmit the feedback 364 for presentation via the user interface 316 on the administrator device 304.

The administrator device 304 may retrieve, identify, or otherwise receive the feedback 364 from the MCP management service 302. With the receipt, the administrator device 304 may render, display, or otherwise present the feedback 364 on the user interface 316. When the indication 362 is of approval, the administrator device 304 may present the indication 362 of approval on the user interface 316. Conversely, when the indication 362 is of disapproval, the administrator device 304 may present the indication 362 of disapproval on the user interface 316. For example, the user interface 316 may display the indication 362 of approval or disapproval with a user interface element and a set of flags to identify which rules the MCP 332 satisfies or did not satisfy. In addition, the user interface 316 may also display a score card using the validation score for the MCP 332. The user of the administrator device 304 may use the information on the user interface 316 to modify the definition of the information for the MCP 332 to include in the MCP schema 352. Upon modification of the definitions, the administrator device 304 may submit another request to validate the MCP 332. The process may be repeated again with the submission of the request.

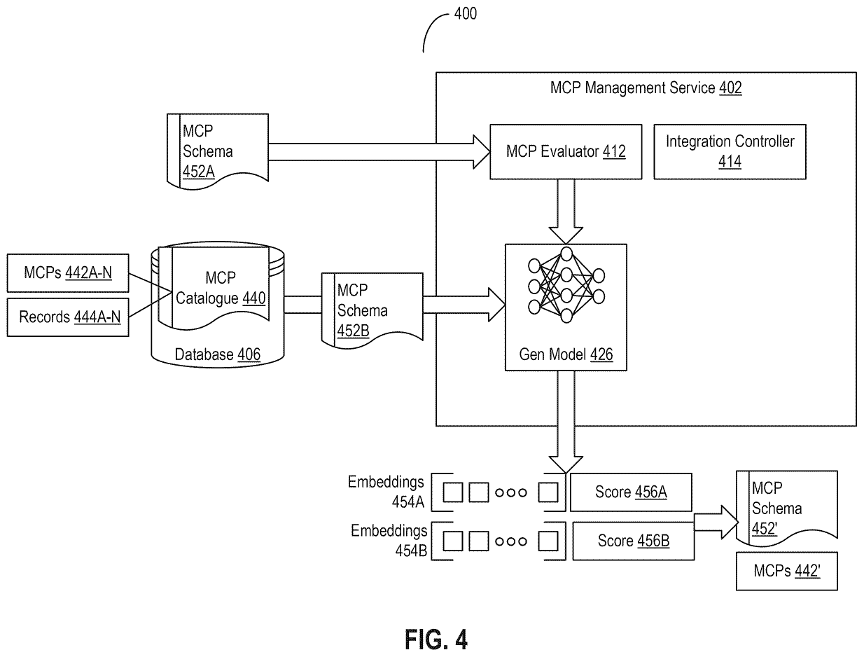

FIG. 4 illustrates a block diagram of a system 400 for finding redundant model context protocols (MCPs) for use in network environments. The system 400 may include at least one MCP management service 402, at least one administrator device 404, and at least one database 406, among others. The MCP management service 402 may include at least one registration handler 410, at least one MCP evaluator 412, at least one integration controller 414, and at least one generative model 426, among others. The database 406 may store or include the MCP catalogue 430, among others. The MCP catalogue 430 may include or identify a set of MCPs 432A-N (hereinafter generally referred to as MCPs 432) and a corresponding set of records 434A-N (hereinafter generally referred to as records 434).

Embodiments may comprise additional or alternative components or omit certain components from those of FIG. 4 and still fall within the scope of this disclosure. Various hardware and software components of one or more public or private networks may interconnect the various components of the system 400. Each component in system 400 (such as the MCP management service 402 and the database 406) may be any computing device comprising one or more processors coupled with a non-transitory memory and software, and capable of performing the various processes and tasks described herein.

The MCP evaluator 412 executing on the MCP management service 402 may apply or execute the generative model 426. The generative model 426 may have been trained or fine-tuned to generate any number of outputs related to MCP schemata. The generative model 426 may have been trained or fine-tuned using a corpus. In some embodiments, the corpus may include MCP schema in non-normalized form (e.g., unstructured and free text) and normalized form (e.g., in expected, standard or canonical form). A portion of the corpus, including the MCP schema in the non-normalized form may be identified as a source set, and another portion of the corpus including the MCP schemata in the normalized form may be identified as a destination set. The generative model 426 may be provided (e.g., by the MCP management service 402) with the source set as input and may generate an output. A distribution of the tokens in the output from the generative model 426 may be compared with a distribution of tokens in the expected output as derived from the destination set. Based on the comparison, a loss metric (e.g., cross-entry loss, a divergence loss, or mean average loss) may be calculated and the loss metric may be used to update the one or more weight in the generative model 426. To execute the generative model 426, the MCP evaluator 412 may generate and provide a prompt directing the generative model 426 to generate the MCP schema 452A in a normalized form (e.g., canonical form).

Based on the execution of the generative model 426, the MCP evaluator 412 may produce, extract, or otherwise generate a set of embeddings 454A for the MCP scheme 452A. The MCP scheme 452A may at least partially define the set of functions available via the MCP 432A for invocation by the one or more AI agents in the network environment. The set of embeddings 454A may include an encoded lower-dimensional representation of the content (e.g., tokens corresponding to words or phrases) of the MCP scheme 452A. In executing the generative model 426, the MCP evaluator 412 may generate or create at least one output including a summarization of the MCP scheme 452A. The summary may be a concise description of the functionalities available through the MCP 432A. For example, the summary of the output may include an identification of one or more functions available for invocation via the MCP 432A as defined by the MCP scheme 452A. Based on executing the generative model 426 using the summary, the MCP evaluator 412 may generate the set of embeddings 454A for the MCP scheme 452A.

The MCP evaluator 412 may identify or determine an occurrence or a lack of redundancy (also referred herein as duplicate or equivalence) between the MCP schema 452A and at least one other MCP schema 452B. The MCP schema 452B may be associated with another MCP 432B in use in the network environment. To determine, the MCP evaluator 412 may select or identify a set of embeddings 454B corresponding to the MCP schema 452B for the MCP 432B. The MCP schema 452B may identify or define a set of functions available for invocation to the one or more AI agents in the network environment via the MCP 432B. The MCP schema 452B and the set of embeddings 454B derived from the MCP schema 452B may be stored and maintained on the database 406. The set of embeddings 454B may be generated in a similar manner as the set of embeddings 454A. In some embodiments, with the identification of MCP schema 452B from the database 406, the MCP evaluator 412 may execute the generative model 428 using the MCP schema 452B (or the summary derived from the MCP schema 452B) to yield the set of embeddings 454B.

With the identification, the MCP evaluator 412 may compare the set of embeddings 454A for the MCP schema 452A with the set of embeddings 454B for the MCP schema 452B. To compare, the MCP evaluator 412 may calculate or determine a distance between the set of embeddings 454A for the MCP schema 452A with the set of embeddings 454B for the MCP schema 452B. The distance may indicate a degree of difference in values between the set of embeddings 454A with the set of embeddings 454B. With the determination, the MCP evaluator 412 may check the distance against a threshold. The threshold may define a value for the distance at which to determine whether the MCP schemas are redundant. If the distance satisfies (e.g., less than or equal to) the threshold, the MCP evaluator 412 may detect the occurrence of the redundancy between the MCP schema 452A and the MCP schema 452B. Conversely, if the distance does not satisfy (e.g., greater than) the threshold, the MCP evaluator 412 may determine the lack of the redundancy between the MCP schema 452A and the MCP schema 452B.

In some embodiments, the MCP evaluator 412 may apply or execute a clustering model using the set of embeddings 454A with the set of embeddings 454B. The clustering model may include or define at least one feature space upon which the sets of embeddings can be assigned as data points (e.g., with dimensions equivalent to the number of embeddings in each set). The clustering model may include a set of clusters in the feature space. The clustering model may have trained and updated using sets of embeddings for MCP schemas used in the network environment. Each cluster may include a subset of the sets of embeddings corresponding to a respective subset of the MCP schemas used in the network environment. From executing the clustering model, the MCP evaluator 412 may identify or determine a first cluster assignment corresponding to one of the clusters for the set of embeddings 454A and a second cluster assignment corresponding to one of the clusters for corresponding to the set of embeddings 454 within the feature space. Based on the cluster assignments, the MCP evaluator 412 may determine the occurrence or the lack of the redundancy. When the cluster assignments are to the same cluster in the clustering model, the MCP evaluator 412 may determine the occurrence of the redundancy between the MCP schema 452A and the MCP schema 452B. On the other hand, when the cluster assignments are to different clusters, the MCP evaluator 412 may determine the lack of the redundancy between the MCP schema 452A and the MCP schema 452B.

When the occurrence of the redundancy is determined, the MCP evaluator 412 may identify or select an MCP 432′ from the MCP 432A for MCP schema 452A and the MCP 432B for the MCP schema 452B. The selection may be based on a comparison of the first set of functions of the MCP 432A and the second set of functions of the MCP 432B. To select, the MCP evaluator 412 may execute the generative model 428 using the MCP schema 452A for the MCP 432A to calculate or determine at least one score 456A. The score 456A may indicate a degree of capability (e.g., number of paths, methods, or schemas) of the set of functions of the MCP 432A. The evaluator 412 may execute the generative model 428 using the MCP schema 452B for the MCP 432B to calculate or determine at least one score 456B. The score 456B may indicate a degree of capability (e.g., number of paths, methods, or schemas) of the set of functions of the MCP 432B.

The integration controller 414 the executing on the MCP management service 402 may select the MCP 432′ from one of the MCPs 432A and 432B for integration, deploy, or use in the network environment. For example, the MCP evaluator 412 may select the MCP 432′ corresponding to the MCP 432A or 432B with the highest score 456A or 456B. In addition, the MCP evaluator 412 may select the MCP schema 452A or 452B corresponding to the selected MCP 432′ as the selected MCP schema 452′. In some embodiments, the MCP evaluator 412 may select the MCPs based on other factors as detailed herein. With the selection of the MCP 432′, the integration controller 414 may update a record corresponding to the non-selected MCP 432 to indicate that the non-selected MCP 432 is redundant. In some embodiments, the integration controller 414 may restrict invocation of the functions defined by the MCP schema 452 of the non-selected MCP 432 by the AI agents in the network environment. When the absence of the redundancy is determined, the MCP evaluator 412 may select both the MCP 432A for MCP schema 452A and the MCP 432B for the MCP schema 452B for use in the network environment. In addition, the MCP evaluator 412 may select both the MCP schema 452A and the MCP schema 452B. In some embodiments, the integration controller 414 may continue to permit invocation of the functions defined by the MCP schemata 452 of both the MCPs 432 by the AI agents in the network environment.

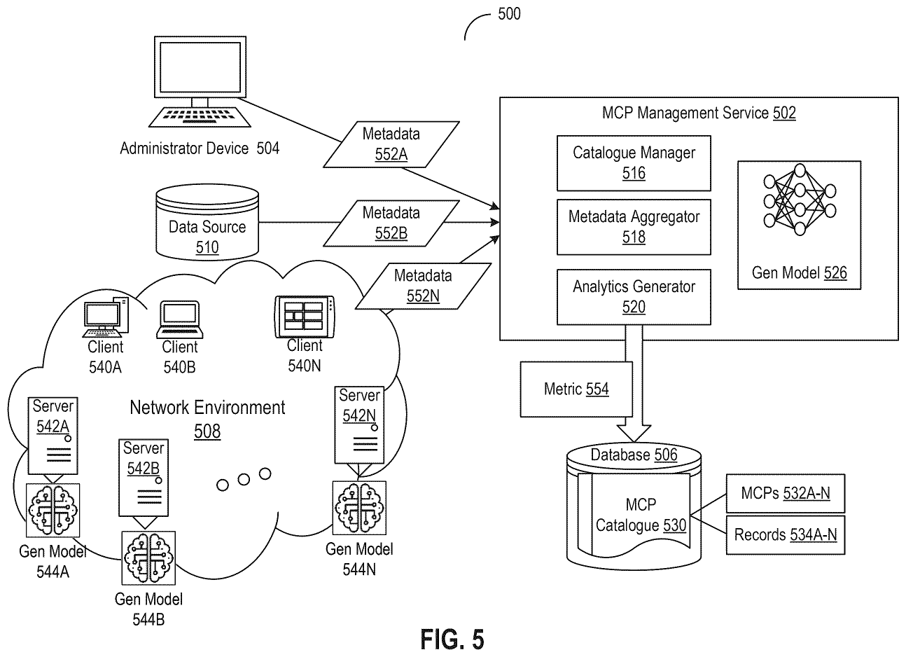

FIG. 5 illustrates a block diagram of a system 500 for aggregating metadata associated with model context protocols (MCPs) from various data sources. The system 500 may include at least one MCP management server 502, at least one administrator device 504, at least one database 506, at least one network environment 508, and at least one data source 510, among others. The MCP management server 502 may include at least one catalogue manager 516, at least one metadata aggregator 518, at least one analytics generator 520, and at least one generative model 526, among others. The database 506 may store, maintain, or otherwise include at least one MCP catalogue 530. The MCP catalogue 530 may include or identify a set of MCPs 532A-N (hereinafter generally referred to as MCPs 532) and a corresponding set of records 534A-N (hereinafter generally referred to as records 534), among others. The network environment 508 may include one or more clients 540A-N (hereinafter generally referred to as client 540) and one or more servers 542A-N (hereinafter generally referred to as servers 542) hosting one or more artificial intelligence (AI) agents 544A-N (hereinafter generally referred to as AI agents 544), among others. The data source 510 may be associated with the entity of the MCP management service 502, among others.

Embodiments may comprise additional or alternative components or omit certain components from those of FIG. 5 and still fall within the scope of this disclosure. Various hardware and software components of one or more public or private networks may interconnect the various components of the system 500. Each component in system 300 (such as the MCP management service 502 or the administrator device 504) may be any computing device comprising one or more processors coupled with memory and software, and capable of performing the various processes and tasks described herein.

The catalogue manager 516 of the MCP management service 502 stores and maintains the MCP catalogue 530 on the database 506. The MCP catalogue 530 may include or identify the set of MCPs 532 (e.g., MCP schemata) and the corresponding set of records 534, among others. Each record 534 may include or identify information about the respective MCP 532. The record 534 may include, for example, information for the MCP 532 itself (e.g., a name of an associated AI agent (or tool), an identifier for a resource (e.g., uniform resource identifier (URI)), an input schema defining a structure for the input to the tool (e.g., prompt with placeholders and defined strings), an output schema defining a structure of the output from the tool); metadata for the MCP 532 (e.g., a domain identifier, an MCP identifier, an MCP version, life cycle stage, a gateway identifier, a product identifier, an MCP version, an owner identifier, an MCP type, a data classification, an authorization level, a geographical region, or organizations); and documentation for the MCP 532, among others. Each record 534 may define or identify at least one of a set of domains associated with the MCP 532. The domains may include those that the MCP 532 is approved for use in the network environment 508. In some embodiments, the record 534 may include information associated with the MCP 532 approved for use in the network environment 508. The catalogue manager 516 may update the MCP catalogue 530.

The metadata aggregator 518 of the MCP management service 502 may aggregate, collect, or otherwise retrieve metadata 552A-N (hereinafter generally referred to as metadata 552) for each MCP 532 on the MCP catalogue 530. Upon integrating or on-boarding the MCP 532 on the network environment 508, the metadata aggregator 518 may monitor data associated with the MCP 532 from various sources. The metadata 552 may be retrieved from various sources, such as the administrator device 504, the network environment 508, and the data source 510 (e.g., associated with the MCP management entity), among others. In some embodiments, the metadata aggregator 518 may receive the metadata 552 including usage data of the MCP 532 in the network environment 508. The usage data may identify or include a rate of requests, throughput, traffic patterns, distribution of devices (e.g., clients 540 or servers 542) using the MCP 532, response times, error rates, and authentications, among others. In some embodiments, the metadata aggregator 518 may receive the metadata 552 including modification of the MCP schema from the data source 510 associated with the MCP management platform. In some embodiments, the metadata aggregator 518 may receive the metadata 552 including the modification of the MCP schema from the administrator device 504. The modification may include any changes to the information on the MCP 532 itself, other previously stored metadata for the MCP 532, or documentation for the MCP 532, among others.

Using the usage data in the metadata 552, the catalogue manager 516 may identify or determine whether the MCP 532 is duplicative or redundant with another MCP 532. The determination may be based on the respective metadata 552 for each of the MCPs 532. To determine, the catalogue manager 516 may compare the metadata 552 of the first MCP 532 with the metadata 552 of the second MCP 532. In some embodiments, the catalogue manager 516 may compare the record 534 (e.g., MCP schema) of the first MCP 532 with the record 534 (e.g., MCP schema) of the second MCP 532. The comparison may be facilitated using a semantic analysis, syntax comparison, functional comparison, input and output schema comparison, or method analysis, among others. Based on the comparison, the catalogue manager 516 may calculate, generate, or otherwise generate a similarity measure. The similarity measure may indicate a degree of similarity between the MCPs 532. When the similarity measure satisfies (e.g., greater than or equal to) a threshold, the catalogue manager 516 may identify or determine that the first MCP 532 is redundant with the second MCP 532. Otherwise, when the similarity measure does not satisfy (e.g., less than) a threshold, the catalogue manager 516 may identify or determine that the first MCP 532 is not redundant with the second MCP 532.

In some embodiments, the catalogue manager 516 may identify or determine whether a version of the MCP 532 is in use or deprecated based on the usage data identified in the metadata 552 for the MCP 532. From the metadata 552, the catalogue manager 516 may extract or identify the usage data for the version of the MCP 532. The catalogue manager 516 may calculate, determine, or otherwise generate at least one metric indicating a degree of usage of the functions available through the MCP 532 of a particular version based on the usage data in the metadata 552. The usage metric may indicate a degree of use (e.g., associated with request rate and traffic patterns) of the MCP 532 within the network environment 508. When the usage metric satisfies (e.g., greater than or equal to) a threshold, the catalogue manager 516 may identify or determine that the version of the MCP 532 is in use. Otherwise, when the usage metric does not satisfy (e.g., less than) a threshold, the catalogue manager 516 may identify or determine that the first MCP 532 is deprecated.

In some embodiments, the catalogue manager 516 may select or identify another version of the MCP 532, when one version of the MCP 532 is determined to be deprecated. The catalogue manager 516 may repeat the determination with another version of the same MCP 532. From the iteration, the catalogue manager 516 may select or identify a substitute version of the MCP 532 to which the network environment 508 to replace the deprecated version of the MCP 532, when the substitute version of the MCP 532 is determined to be in use. With the identification, the catalogue manager 516 may send, communicate, or otherwise transmit at least one message 560 to indicate to one or more of the AI agents 544 in the network environment 508. The message 560 may indicate the replacement of the deprecated version of the MCP 532 with the new, substitute version of the MCP 532. For instance, the message 560 may be a directive to the AI agent 544 that was previously using the now-deprecated MCP 532 to access tools and resources provided by another AI agent to switch over to the newly identified MCP 532.

In some embodiments, the catalogue manager 516 may calculate, generate, or otherwise determine at least one metric indicating a level of risk of the MCP 532 to the network environment 508 based on the metadata 552. To determine, the catalogue manager 516 may evaluate or check the usage data in the metadata 552 against the policy used to validate the MCP 532. From checking, the catalogue manager 516 may determine whether the MCP 332 satisfies the set of conditions defined by the policy. The metric indicating a level of risk of the MCP 532 may be a function of a number of instances of non-compliance or violations with respect to the set of conditions. Using the metric indicating the level of risk, the catalogue manager 516 may update the record 534 for the MCP 532.

Based on the metric, the catalogue manager 516 may control or regulate access to invocation of the functions of the MCP 532 by AI agents in the network environment 508. In some embodiments, the catalogue manager 516 may assign or classify the MCP 532 into one of a set of classifications in accordance with the metric. The set of classifications may, for example, correspond to different levels of risk, such as high risk, intermediate risk, and low risk, among others. Based on the classification of the MCP 532 and the type of tool of a given AI agent, the catalogue manager 516 may permit or restrict the AI agent from accessing the functions of the MCP 532. For instance, for an AI agent that is a banking tool relying on exchange of encrypted, sensitive information, the catalogue manager 516 may restrict access of functions with the MCP 532 that has the high-risk classification.

The analytics generator 520 of the MCP management service 502 creates, determines, or otherwise generates performance metrics 554 for the MCP 532 using the metadata 552 including usage data from the network environment 508. The performance metrics may indicate or identify various operational aspects of the MCP 532, and may include, for example, request rates, response time, latency, throughput, error rates, availability, and downtime, among others. The analytics generator 520 may generate the performance metrics 554 for the MCP 532 over a defined time period (e.g., days, weeks, months, or years) based on the metadata 552. The analytics generator 520 may generate the performance metrics 554 as a function of the usage indicated int the metadata 554 for the MCP 532.

Using the metadata 552, the catalogue manager 516 may change, modify, or otherwise update the record 534 on the MCP catalogue 530. In some embodiments, the catalogue manager 516 may update the record 534 to include the indication of whether the MCP 532 is redundant with another MCP 532 in the network environment 508. The record 534 may include an identification of two or more MCPs 532 identified as redundant. In some embodiments, the catalogue manager 516 may update the record 534 to include an indication of whether the version of the MCP 532 is in use or deprecated. If deprecated, the catalogue manager 516 may also update the record 534 to include an identification of another version of the MCP 532 in use. In some embodiments, the catalogue manager 516 may update the record 534 to include the classification for the MCP 532. In some embodiments, the catalogue manager 516 may update the record 534 to include the graph generated using the metadata 552 for the MCP 532. In some embodiments, the catalogue manager 516 may update the record 534 to include the performance metrics 554. The catalogue manager 516 may update the records 534 on the MCP catalogue 530 as more and more metadata 552 is aggregated from the various data sources.

In some embodiments, using the metadata 552, the catalogue manager 516 may change, modify, or otherwise update the record 534 on the API catalogue 630. In some embodiments, the catalogue manager 516 may apply or execute the generative model 528 using the metadata 552. The generative model 526 may have been trained or fine-tuned using a corpus. In some embodiments, the corpus may include data related to API specifications in non-normalized form (e.g., unstructured and free text) and the API specification in normalized form (e.g., in expected, standard or canonical form). A portion of the corpus including the API specification in the non-normalized form may be identified as a source set, and another portion of the corpus including the API specification in the normalized form may be identified as a destination set. The generative model 526 may be provided (e.g., by the API management service 502) with the source set as input and may generate an output. A distribution of the tokens in the output from the generative model 526 may be compared with a distribution of tokens in the expected output as derived from the destination set. Based on the comparison, a loss metric (e.g., cross-entry loss, a divergence loss, or mean average loss) may be calculated and the loss metric may be used to update the one or more weight in the generative model 526. To execute the generative model 526, the catalogue manager 516 may generate and provide a prompt directing the generative model 526 to generate data to add to the record 534 in canonical form (e.g., with the defined set of fields and values). The catalogue manager 516 may add the data (e.g., updated values from the metadata 554) generated based on executing the generative model 526 to the corresponding record 534.

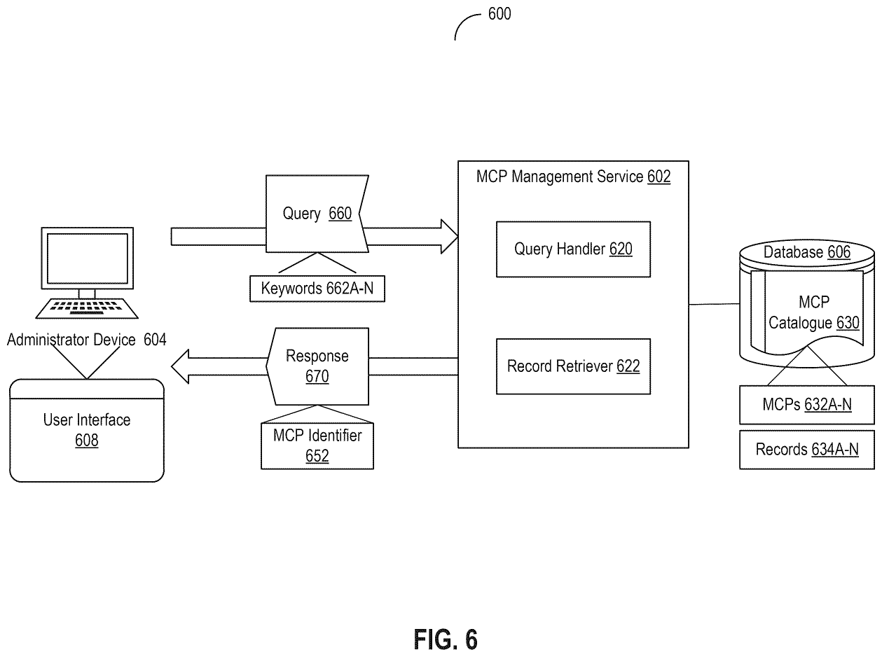

FIG. 6 illustrates a block diagram of a system 600 for accessing application programming interface (API) catalogues used in network environments. The system 600 may include at least one MCP management service 602, at least one administrator device 604, and at least one database 606, among others. The MCP management service 602 may include at least one query handler 620 and at least one record retriever 622, among others. The administrator device 604 may provide at least one user interface 608. The database 606 may store, maintain, or otherwise include at least one MCP catalogue 630. The MCP catalogue 630 may identify or include a set of MCPs 632A-N (hereinafter generally referred to as MCPs 632) and a corresponding set of records 634A-N (hereinafter generally referred to as records 634), among others.

Embodiments may comprise additional or alternative components or omit certain components from those of FIG. 6 and still fall within the scope of this disclosure. Various hardware and software components of one or more public or private networks may interconnect the various components of the system 600. Each component in system 600 (such as the MCP management service 602, the administrative device 604, or the database 606) may be any computing device comprising one or more processors coupled with memory and software, and capable of performing the various processes and tasks described herein.

The query handler 620 of the MCP management service 602 may send, transmit, or otherwise provide the user interface 608 to the administrator device 604. In some embodiments, the query handler 620 may transmit or send an instruction to display, render, or otherwise present the user interface 608 via the administrator device 604. The user interface 608 may be a graphical user interface of an application (e.g., web application) supported by the MCP management service 302. The user interface 608 may include one or more fields (e.g., user interface elements) for searching for MCPs 632 from the catalogue 630. For example, the fields may include or identify a domain, a functionality, or application, version, classification, or any metadata detailed herein associated with the MCP 632. In some embodiments, the query handler 620 may execute a chatbot using machine learning, artificial intelligence (AI) algorithms, or rules-based systems, among others. The chatbot may simulate conversation with the user on the administrator device 604 to accept input from the user and to generate outputs indicating search query results to the user. The user interface 608 may be a chat interface (e.g., as part of a conversation interface) to enter input for the chatbot.

The administrator device 604 may retrieve, obtain, or otherwise receive the user interface 608 from the MCP management service 602. For instance, the administrator device 604 may receive the instruction for presentation of the user interface 608 from the MCP management service 602. With the receipt, the administrator device 604 may present the user interface 608 via a display and may accept user inputs on the user interface 608. Using the information inputted on the user interface 608, the administrator device 304 may create, write, or otherwise generate at least one query 660. The query 660 may identify or include one or more keywords 662A-N (hereinafter generally referred to as keywords 662) to be used to find MCPs 632. The query 660 (or at least one of the keywords 662) may identify at least one domain to be searched for the MCPs 632. In some embodiments, the query 660 may be generated using input on the chat interface (e.g., conversational interface).

The query handler 620 may retrieve, identify, or otherwise receive the query 660 form the administrator device 604. With receipt, the query handler 620 may process or parse the query 660 to extract or identify the keywords 662 from the query 660. In some embodiments, the query handler 620 may identify the keywords 662 from the inputs on the chat interface for the chatbot. In some embodiments, the query handler 620 may identify the domain to be searched from the query 660. With the identification, the query handler 620 may produce or generate additional keywords in accordance with keyword expansion. The generation of additional keywords may be in accordance with a semantic graph identifying related keywords and phrases.

Based on the keywords 662 of the query 660 and the records 634 (or metadata), the record retriever 622 may identify or select one or more records 634 for a corresponding MCPs 632 from the MCP catalogue 630. The selection may be based on the keywords 662 matching or corresponding with at least a portion of the records 634. The record retriever 622 may use a search engine or algorithm to select the records 634. In some embodiments, the record retriever 622 may select an initial set of records 634 for the corresponding MCPs 632 based on the domain identified in the query 660. From the initial set, the record retriever 622 may use the keywords 662 to select the one or more records 634. In some embodiments, the record retriever 622 may select the record 634 using the keywords 662 and the graphs in the records 634. For instance, the record retriever 622 may select the records 634 based on the keywords 662 matching nodes in the graphs of the records 634.

With the selection, the record retriever 622 may produce, output, or otherwise transmit at least one response 670 to provide to the administrator device 604. The response 670 may identify or include at least one MCP identifier 652. The MCP identifier 652 may identify a respective record 634 and by extension the corresponding MCP 632 from the MCP catalogue 630. In some embodiments, the record retriever 622 may generate the response 670 to include information associated with the MCP 632, such as the performance metrics, the MCP schema, metadata, and domains, among others. With the generation, the record retrieve 622 may provide, send, or otherwise transmit the response 670 to the administrator device 604 for presentation on the user interface 608. The administrator device 604 may retrieve, identify, or otherwise receive the response 670 from the MCP management service 602. With receipt, the administrator device 604 may render, display, or otherwise present the MCP identifier 652 on the user interface 608. In some embodiments, the administrator device 604 may present the information associated with the MCP 632 such as the performance metrics, the MCP schema, metadata, and domains, among others.

In this manner, the MCP management service may provide for centralized records of MCPs available for use in the network environment. The use of templates for MCP schemas may improve consistency and standardize MCP related information. By controlling integration of MCPs into the network environment, the service may further ensure that the MCP schema are successfully validated and tested prior to the integration. The continuous monitoring by the service may allow for lifecycle management of the MCPs from development, deployment, versioning, and deprecation. The centralized catalogue may also provide a consistent and standardized information about MCPs, as well as performance metrics of the MCPs used in the network environment. With the improvement in the MCP governance for the network environment, the computing resources and network bandwidth of the servers and clients in the network environment may be more efficiently allocated. Furthermore, new MCPs may be deployed in a standard and consistent manner, thereby increasing the adaptation of newer functionality in the network environment.

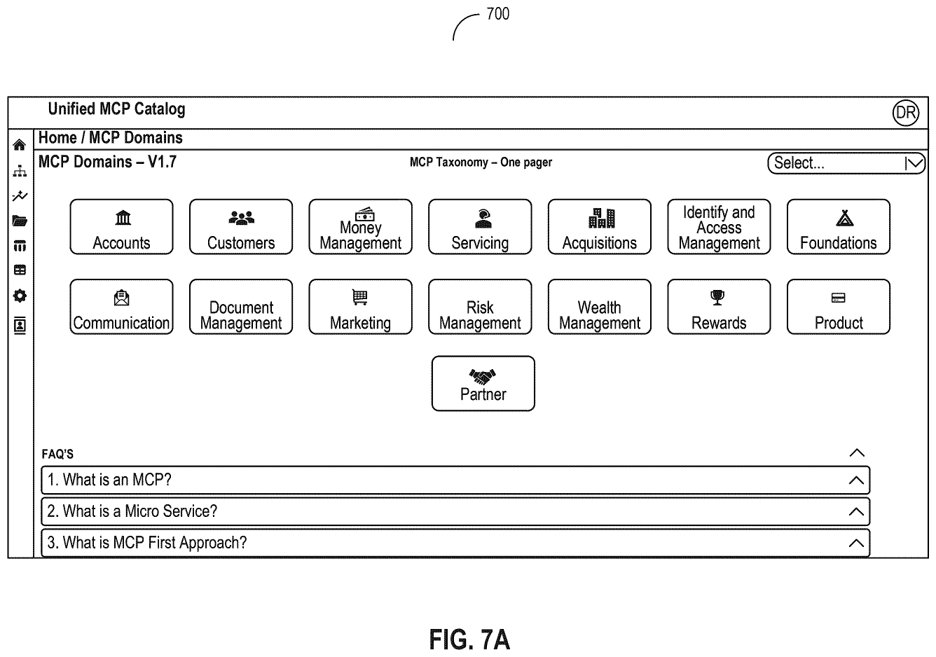

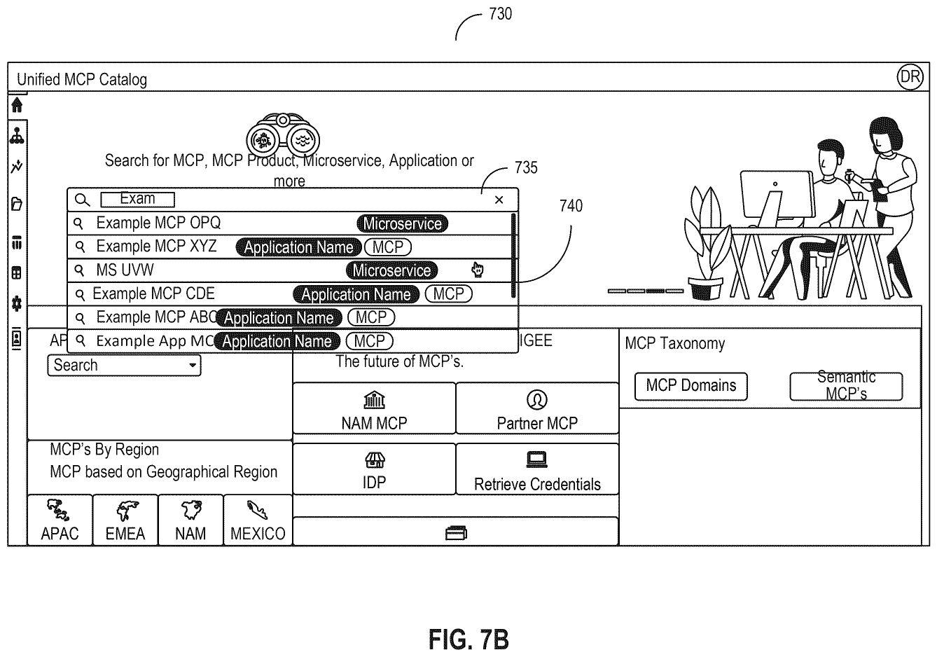

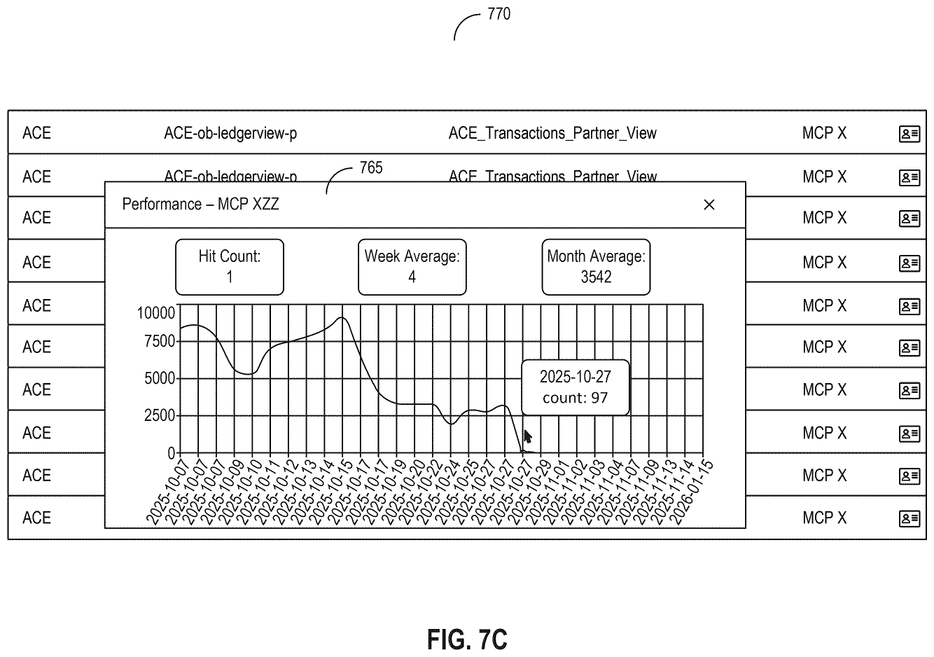

FIG. 7A illustrates a screenshot of a user interface 700 with a list of domains for MCP catalogues. The user interface 700 may include a list of MCP taxonomies (or domains), such as accounts, customers, money management, servicing, acquisitions, access management, foundations, communications, document management, marketing, wealth management, rewards, products, and partnerships, among others. The user may select one of the taxonomies on the user interface 700 to view which MCPs are available in each taxonomy.

FIG. 7B illustrates a screenshot of a user interface 730 to search application programming interface (API) catalogues. The user interface 730 may be the graphical user interface for querying the MCP catalogue. The user interface 730 may include at least one search field 735 to enter one or more keywords. As the user types in the keywords for searching the MCP catalogue, the user interface 730 may display a list of results 740. The list of results 710 may identify a set of MCPs corresponding to the keywords. The user may select one of the results to view further information about the MCP. FIG. 7C illustrates a screenshot of a user interface 760 including performance metrics for model context protocols (MCPs). The user interface 760 may include at least one performance metrics window 765. The performance metrics window 765 may include usage of the given MCP (e.g., “API XZZ”) across a time.

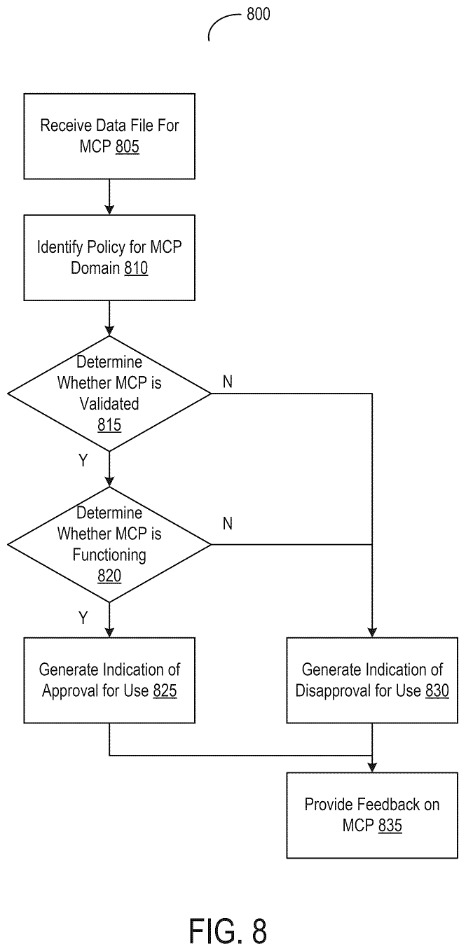

FIG. 8 illustrates a flow diagram of a method 800 of integrating model context protocols (MCPs) for use in networked environments. The method 800 may be performed by a service (e.g., an MCP management service) executing machine-readable software code, though it should be appreciated that the various operations may be performed by one or more computing devices and/or processors. At step 805, a service may receive a data file, at least partially defining the MCP schema. The MCP schema may be provided as part of a registration request to add the MCP to a network environment. The request may identify a domain (e.g., a tool or function type) for the MCP. The information may be generated from data inputted onto a dashboard interface.

At step 810, the service may identify a policy for the MCP domain from a set of domains. Upon receipt, the service may parse the request to identify the domain associated with the MCP. The service may select the policy from a set of policies associated with the domain. Each policy may specify a set of rules for validating the MCP and performance criterion for the MCP to be approved for addition to the network environment. At step 815, the service may determine whether the MCP is validated in accordance with the policy. The service may run a validation test on the MCP in accordance with the set of rules of the policy for validation. At step 820, if the MCP is determined to be validated, the service may determine whether the MCP is properly functioning. The service may run a performance test on the MCP in accordance with the set of rules of the policy for performance.

At step 825, when the MCP is determined to be validated and to be properly functioning, the service may generate an indication of approval for use. The service may perform on-boarding and integration of the MCP to the network environment, by permitting AI agents and services in the network environment to invoke functions defined by the MCP. At step 830, when the MCP is determined to be not validated or not properly functioning, the service may generate an indication of disapproval for use. The service may also restrict the MCP from use in the network environment. At step 835, the service may provide feedback on the MCP based on the indication. The feedback may include the indication of approval or disapproval of the MCP. The service may also generate the feedback to include which rules the MCP was not compliant with.

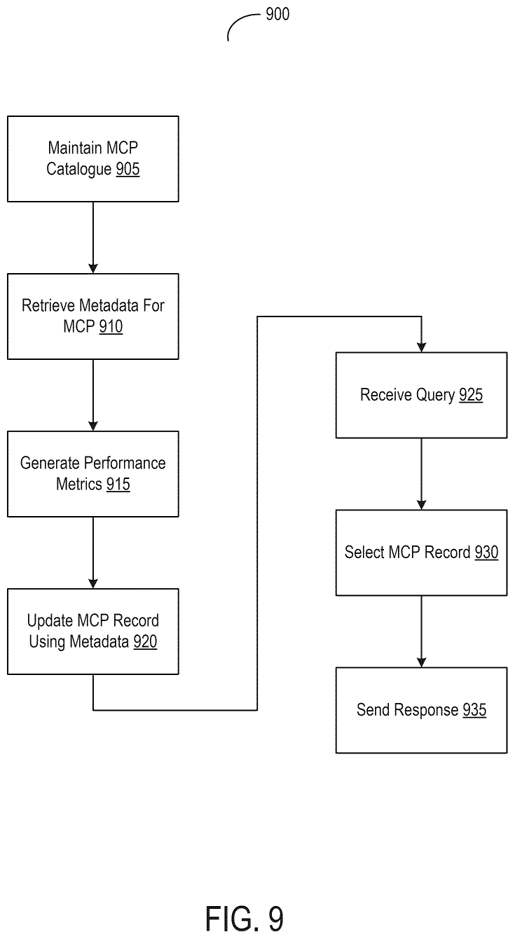

FIG. 9 illustrates a flow diagram of a method 900 of cataloguing model context protocols (MCPs) using metadata. The method 900 may be performed by a service (e.g., an MCP management service) executing machine-readable software code, though it should be appreciated that the various operations may be performed by one or more computing devices and/or processors. At step 905, a service may maintain an MCP catalogue. The MCP catalogue may include a set of MCP records for a corresponding set of MCPs. Each record may contain information associated with the MCP, such as the specification, metadata, and domain, among others. The information may be standardized across each associated domain in accordance with a template for the catalogue.

At step 910, the service may retrieve metadata for each MCP on the MCP catalogue. Once the MCP is integrated into a defined network environment, the service may monitor for the metadata for the MCP from various sources, such as the clients, servers, and AI agents in the network environment, the administrator of the network or MCPs, and the MCP management platform, among others. The metadata may indicate usage of the MCP within the network environment. At step 915, the service may generate performance metrics based on the usage of the MCP within the network environment. The performance metrics may include, for example, request rates, response time, latency, throughput, error rates, availability, and downtime, among others. At step 920, the service may update the MCP record using the metadata retrieved for the MCP. The service may update the MCP to include performance metrics, classification, version deprecation, and redundancies, among others.

At step 925, the service may receive a query to find MCPs from the MCP catalogue. The query may include one or more keywords. The query may identify a domain associated with the MCP. Upon receipt, the service may parse the query to extract or identify the keywords. At step 930, the service may select one or more MCP records from the MCP catalogue using the keywords of the query. The service may search the MCP catalogue to find MCP records corresponding to the keywords. At step 935, the service may send a response to identify the MCP records corresponding to the keywords. The service may include information about the MCP (e.g., MCP schema, metadata, performance metrics) in the response.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then” and “next,” among others, are not intended to limit the order of the steps; these words are simply used to guide the reader through the description of the methods. Although process flow diagrams may describe the operations as a sequential process, many of the operations can be performed in parallel or concurrently. In addition, the order of the operations may be rearranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, among others, may be passed, forwarded, or transmitted via any suitable means including memory sharing, message passing, token passing, network transmission, etc.

The actual software code or specialized control hardware used to implement these systems and methods is not limiting. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method of integrating model context protocols (MCPs) for use in network environments, comprising:
retrieving, by one or more processors, a data file comprising an MCP schema defining a plurality of functions of a MCP for a generative model for use in a network environment;
identifying, by the one or more processors, from a plurality of domains, a domain using the MCP schema in the data file;
selecting, by the one or more processors, from a plurality of policies corresponding to the plurality of domains, a policy defining a set of conditions against which the MCP schema is to be validated for integration of the MCP in the network environment based on the domain;
determining, by the one or more processors, that the MCP schema for the MCP is validated in accordance with the set of conditions defined by the policy;
configuring, by the one or more processors, based on determining that the MCP schema is validated, a data record on a database to indicate an approval of the MCP for use in the network environment; and
executing, by the one or more processors, an integration of the MCP to permit invocation of the plurality of functions of the MCP in the network environment.

2. The method of claim 1, further comprising:
determining, by the one or more processors, that a second MCP schema for a second MCP is not validated in accordance with the set of conditions defined by the policy;
configuring, by the one or more processors, responsive to determining that the second MCP schema is not validated, a second data record on the database to indicate a disapproval of the MCP for use in the network environment; and
restricting, by the one or more processors, invocation of a second plurality of functions defined by the second MCP schema for the second MCP.

3. The method of claim 1, further comprising:
receiving, by the one or more processors, from the network environment, metadata comprising usage data of the plurality of functions of the MCP for the generative model invoked by one or more second generative models; and
updating, by the one or more processors, the data record for the MCP on the database using the usage data included in the metadata.

4. The method of claim 1, further comprising:
generating, by the one or more processors, a metric indicating a degree of usage of the plurality of functions of the MCP of a first version based on metadata for the MCP of the first version;
determining, by the one or more processors, that the MCP of the first version is deprecated based on the metric not satisfying a threshold; and
transmitting, by the one or more processors, to a second generative model, a message to indicate that the MCP of the first version is deprecated.

5. The method of claim 4, further comprising identifying, by the one or more processors, a second version of the MCP to replace the first version of the MCP based on the metadata, responsive to determining that the first version is deprecated,
wherein transmitting the message further comprises transmitting the message to indicate replacement of the first version with the second version.

6. The method of claim 1, further comprising:
generating, by the one or more processors, using a second generative model, (i) a first plurality of embeddings corresponding to the MCP schema for the generative model and (ii) a second plurality of embeddings corresponding to a second MCP schema for a third generative model; and
determining, by the one or more processors, a redundancy between the MCP schema for the generative model and the second schema for the third generative model based on a comparison of the first plurality of embeddings and the second plurality of embeddings.

7. The method of claim 6, further comprising:
updating, by the one or more processors, the data record for the MCP to indicate that the MCP schema is redundant; and
restricting, by the one or more processors, invocation of the plurality of functions defined by the MCP schema for the MCP, responsive to updating the data record.

8. The method of claim 1, further comprising:
generating, by the one or more processors, using a second generative model, (i) a first plurality of embeddings corresponding to the MCP schema for the generative model and (ii) a second plurality of embeddings corresponding to a second MCP schema for a third generative model; and
determining, by the one or more processors, a lack of redundancy between the MCP schema for the generative model and the second schema for the third generative model based on a comparison of the first plurality of embeddings and the second plurality of embeddings; and
permitting, by the one or more processors, invocation of the plurality of functions defined by the MCP schema and of a second plurality of functions defined by the second schema.

9. The method of claim 1, further comprising:
determining, by the one or more processors, a metric indicating a level of risk of the MCP to the network environment based on metadata of the MCP;
updating, by the one or more processors, the data record for the MCP using the metric indicating the level of risk; and
controlling, by the one or more processors, access to invocation of at least one of the plurality of functions of the MCP.

10. The method of claim 1, wherein executing the integration further comprises permitting one or more artificial intelligence (AI) agents to exchange data with the generative model via the MCP and to access the plurality of functions of the MCP for the generative model.

11. A system for deploying model context protocols (MCPs) in network environments, comprising:
one or more processors coupled with a non-transitory memory, configured to:
retrieve a data file comprising an MCP schema defining a plurality of functions of a MCP for a generative model for use in a network environment;
identify, from a plurality of domains, a domain using the MCP schema in the data file;
select, from a plurality of policies corresponding to the plurality of domains, a policy defining a set of conditions against which the MCP schema is to be validated for integration of the MCP in the network environment based on the domain;
determine that the MCP schema for the MCP is validated in accordance with the set of conditions defined by the policy;
configure, based on determining that the MCP schema is validated, a data record on a database to indicate an approval of the MCP for use in the network environment; and
execute an integration of the MCP to permit invocation of the plurality of functions of the MCP in the network environment.

12. The system of claim 11, wherein the one or more processors are further configured to:
determine that a second MCP schema for a second MCP is not validated in accordance with the set of conditions defined by the policy;
configure, based on determining that the second MCP schema is not validated, a second data record on the database to indicate a disapproval of the MCP for use in the network environment; and
restrict invocation of a second plurality of functions defined by the second MCP schema for the second MCP.

13. The system of claim 11, wherein the one or more processors are further configured to:
receive, from the network environment, metadata comprising usage data of the plurality of functions of the MCP for the generative model invoked by one or more second generative models; and
update the data record for the MCP on the database using the usage data included in the metadata.

14. The system of claim 11, wherein the one or more processors are further configured to:
generate a metric indicating a degree of usage of the plurality of functions of the MCP of a first version based on metadata for the MCP of the first version;
determine that the MCP of the first version is deprecated based on the metric not satisfying a threshold; and
transmit, to a second generative model, a message to indicate that the MCP of the first version is deprecated.

15. The system of claim 14, wherein the one or more processors are further configured to:
identify a second version of the MCP to replace the first version of the MCP based on the metadata, responsive to determining that the first version is deprecated;
transmit, to the second generative model, the message to indicate replacement of the first version with the second version.

16. The system of claim 11, wherein the one or more processors are further configured to:
generate, using a second generative model, (i) a first plurality of embeddings corresponding to the MCP schema for the generative model and (ii) a second plurality of embeddings corresponding to a second MCP schema for a third generative model; and
determine a redundancy between the MCP schema for the generative model and the second schema for the third generative model based on a comparison of the first plurality of embeddings and the second plurality of embeddings.

17. The system of claim 16, wherein the one or more processors are further configured to:
update the data record for the MCP to indicate that the MCP schema is redundant; and
restrict invocation of the plurality of functions defined by the MCP schema for the MCP, responsive to updating the data record.

18. The system of claim 11, wherein the one or more processors are further configured to:
generate, using a second generative model, (i) a first plurality of embeddings corresponding to the MCP schema for the generative model and (ii) a second plurality of embeddings corresponding to a second MCP schema for a third generative model; and
determine a lack of redundancy between the MCP schema for the generative model and the second schema for the third generative model based on a comparison of the first plurality of embeddings and the second plurality of embeddings; and
permit invocation of the plurality of functions defined by the MCP schema and of a second plurality of functions defined by the second schema.

19. The system of claim 11, wherein the one or more processors are further configured to:
determine a metric indicating a level of risk of the MCP to the network environment based on metadata of the MCP;
update the data record for the MCP using the metric indicating the level of risk; and
control access to invocation of at least one of the plurality of functions of the MCP.

20. The system of claim 11, wherein the one or more processors are further configured to permit one or more artificial intelligence (AI) agents to exchange data with the generative model via the MCP and to access the plurality of functions of the MCP for the generative model.
